(19) United States
(12) Patent Application Publication
(10) Pub. No.: US 2021/0153673 A1
(43) Pub. Date: May 27, 2021

(54) METHOD AND DEVICE FOR AN AUTOMATED SEASONING OF FOOD

(71) Applicant: Vorwerk & Co. Interholding GmbH, Wuppertal (DE)

(72) Inventor: Kevin Schmitz, Düsseldorf (DE)

(21) Appl. No.: 17/100,305

(22) Filed: Nov. 20, 2020

(30) Foreign Application Priority Data
Nov. 21, 2019 (EP) 19210544.3

(51) Int. Cl. A47G 19/34; A47J 47/01; B65D 83/06; A23P 20/12

(52) U.S. Cl. CPC A47G 19/34; A23P 20/12; B65D 83/06; A47J 47/01

(57) ABSTRACT

The present disclosure relates to (i) a method for preparing a food with a food preparation apparatus and (ii) an electrically operable spice dispensing device for performing the method. The food preparation apparatus has a food preparation space. The spice dispensing device comprises a spice chamber for storing a spice and a dosing device through which a spice can be removed from the spice chamber in a dosed manner. Even without expert knowledge, the present disclosure enables seasoning without any errors during the preparation of a food.

### CROSS REFERENCE TO RELATED APPLICATIONS

This application claims priority to and the benefit of European Patent Application Number 19210544.3, filed 21 Nov. 2019, the disclosure of which is now expressly incorporated herein by reference.

### FIELD OF THE DISCLOSURE

The present disclosure relates to a method for a seasoning of a food and a spice dispensing device.

### BACKGROUND

Food is prepared by processing ingredients. Food preparation apparatuses such as the Thermomix® food processor can be used to prepare food. The Thermomix® food processor can weigh, heat, mix and/or chop ingredients for a food in an associated food preparation vessel. The preparation of a food can be performed according to the recipe steps of a recipe step by step in a semi-automated manner with the Thermomix® food processor.

Since ingredients brought into the food preparation vessel can be weighed, incorrect dosages can easily be avoided. However, this does not apply to spices, as the quantities required are too small to be weighed with sufficient accuracy.

Spice dispensing devices can be used to add spices during food preparation. For example, there are handheld spice mills that can dispense spices by rotating a grinder.

The rotation of the grinder of a spice mill can be done by means of an electric motor. In such electric spice mills, a button can be actuated by the user. As long as the button is actuated, the grinder rotates by means of the electric motor and the corresponding spice, such as pepper, is dispensed. The dosage of the spice thus dispensed depends on how long the button is actuated. The dosage is therefore manual.

### SUMMARY

It is the task of the present disclosure to create a method for seasoning a food by which incorrect dosages can be avoided. It is further the task of the present disclosure to create a manually operated spice dispensing device for performing the method.

The present disclosure provides a method and a manually operated spice dispensing device for preparing a food with a food preparation apparatus. In the food preparation apparatus, a food can be prepared according to recipe steps of a recipe controlled by an electronic control unit. For example, the food preparation apparatus may be a food processor, an oven, a microwave, a steamer, or a stove. A food in the sense of the present disclosure comprises edible and drinkable food, thus also beverages.

In the following, the disclosed method and apparatus is illustrated in more detail by means of figures. These are only examples, which do not limit the scope of protection of the patent claims.

### BRIEF DESCRIPTIONS OF THE DRAWINGS

The figures show:

FIG. 1: Cylindrical spice dispensing device;

FIG. 2: Sectional view of the spice dispensing device of FIG. 1;

FIG. 3: Cuboid spice dispensing device;

FIG. 4: Top view of spice dispensing device;

FIG. 5: Spice dispensing device with stationary components;

FIG. 6: Spice dispensing device with stationary components and drawer as collection chamber;

FIG. 7: Dosing unit;

FIG. 8: Food processor.

### DETAILED DESCRIPTION

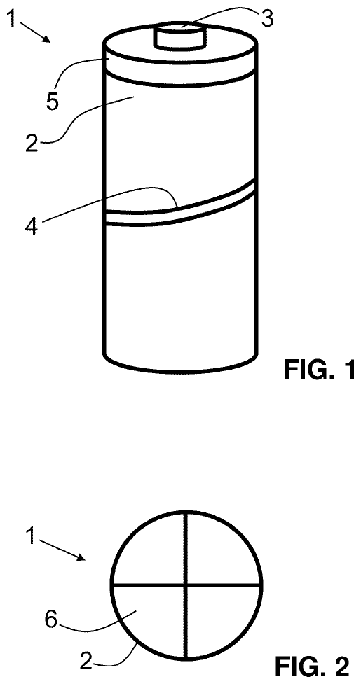

FIG. 1 shows a handheld spice dispensing device 1 according to the present disclosure with a housing 2, which can be cylindrical. The spice dispensing device 1 can be held and operated with one hand, similar to a standard pepper mill. On the upper side of the housing 2 there may be a button 3 which can be pressed. By pressing the button 3, spice can be dispensed from the spice dispensing device 1. Thus, if a user is prompted by a signal to season ingredients in a food preparation vessel as part of a method, the user can hold the spice dispensing device 1 over the food preparation vessel and perform the seasoning process by pressing the button 3. The required spices are then automatically dispensed in the food preparation vessel in a dosed manner in appropriate quantities.

The spice dispensing device 1 can have a LED strip 4 as signal device. The LED strip 4 can run annularly around the housing 2. This ensures that the LED strip 4 is always visible when the spice dispensing device 1 is in the user's field of vision. The LED strip 4 can preferably light up in different colors. It is therefore possible to signal a meaning by selecting a light color. For example, a green light color can signal that spice dispensing device 1 is ready for operation. A yellow light color can signal that by means of the spice dispensing device 1 according to a recipe step, ingredients in a food preparation space are to be spiced with this spice dispensing device 1. For example, an orange light color may indicate that a rechargeable battery of the spice dispensing device 1 should be charged or a non-rechargeable battery should be replaced. The spice dispensing device 1 may comprise a removable cap 5. For example, the cap 5 can be unscrewed to allow refilling of spice chambers in the spice dispensing device 1.

Instead of an LED strip 4, there can also be a plurality of light sources around the circumference of the housing 2 so that a user can see at least one light source when the spice dispensing device 1 is in his field of view. Each light source can then be, for example, a point light source.

FIG. 2 shows a sectional view of the spice dispensing device 1 of FIG. 1. This sectional view shows that there are a total of four spice chambers 6 within the housing 2, which are available for storing four different spices. Instead of four spice chambers 6, there can also be more or less spice chambers.

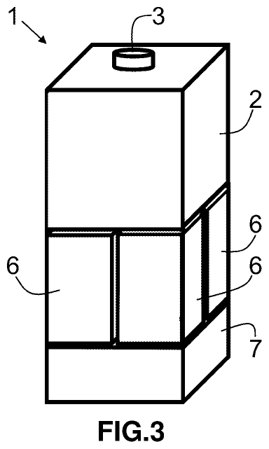

FIG. 3 shows a spice dispensing device 1 according to the present disclosure with a housing 2, which can be cuboid as shown in FIG. 3. The spice dispensing device 1 can be held and operated with one hand similar to a standard pepper mill. In the housing 2 there may be located one or more electric drives. An electric drive may be provided to dose a spice by means of the electric drive. In the housing 2 there may be located a sending and/or receiving unit to be able to receive and/or send data wirelessly. An electronic control unit may be located in housing 2. The control unit can comprise a processor and one or more electronic memory modules.

In the housing 2 there may be located locking devices by means of which the spice chambers 6 can be locked if they are inserted as shown in FIG. 3. The spice chambers can be detachably locked so that spice chambers 6 can be removed and replaced.

An electric drive inside the housing 2 can be provided to fix spice chambers 6 when they are inserted. With such an electric drive, the fixation can be loosened in order to exchange one or more spice chambers.

The spice chambers 6 are designed for storing spices, in particular for storing dry spices like salt, pepper, sugar or a spice mixture such as curry powder. The spice chambers 6 can be exchanged in order to be able to replace an empty spice chamber 6 by a full spice chamber 6. Instead of four spice chambers 6, more or less spice chambers 6 for spices can also be provided.

Below the spice chambers 6, there may be a collection chamber 7 for spices which is open at the top. Collection chamber 7 may be removable to allow it to be brought to a food preparation space for emptying after one or more spices have been brought in a dosed manner from one or more spice chambers 6 to collection chamber 7. Thus, if a user is prompted by a signal to season ingredients in a food preparation vessel as part of a method, the user may remove the collection chamber 7 and pour its contents into the food preparation vessel for seasoning. In this way, the required spices are then dispensed into the food preparation vessel in a dosed manner in appropriate quantities. The collection chamber 7 can be connected to the remaining part of the spice dispensing device 1 in the form of a drawer.

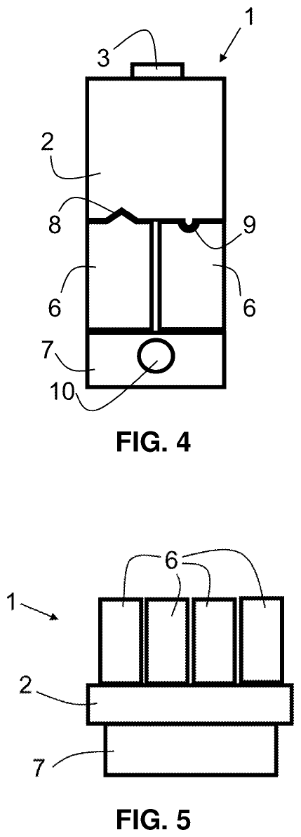

FIG. 4 shows a top view of a spice dispensing device 1. The spice chambers 6 and the housing 2 have bulges or projections 8 and 9 corresponding to each other in such a way that each spice chamber 6 can only be used in a single location intended for this purpose. Thus, the spice chamber 6 shown on the left cannot be inserted on the right side and vice versa. This prevents confusion, which could lead to incorrect results when preparing food. In this embodiment it is advantageous that spice chambers 6 cannot be refilled by the end user, in order to avoid errors when the spice chamber is refilled by an end user or user.

In one embodiment, however, it can also be graphically illustrated which spice chamber 6 can be used in which position. For example, a first spice chamber 6 can be colored yellow and the corresponding part above the housing can also be colored yellow. A second spice chamber 6 can be colored green and the corresponding part above the housing can also be colored green. Such color markings make it easy to visually determine whether spice chambers with spices in them are inserted correctly. This embodiment is also suitable for avoiding confusion, which could lead to incorrect results when preparing food.

The collection chamber 7 can comprise a side opening 10 through which the contents of the collection chamber 7 can be emptied for seasoning.

FIG. 5 shows a partly handheld spice dispensing device 1 according to the present disclosure with a housing 2, which can be cuboid as shown. In the housing 2 there may be located one or more electric drives. An electric drive may be provided to dose a spice by means of the electric drive. A sending and/or receiving unit can be located in housing 2 in order to receive and/or send data wirelessly. An electronic control unit can be located in housing 2. The control unit may comprise a processor and one or more electronic memory modules.

In the housing 2 there may be located locking devices by means of which spice chambers 6 placed on top of the housing can be locked, if they are placed on top as shown in FIG. 5. The spice chambers 6 can be detachably locked so that spice chambers 6 can be removed and replaced.

An electric drive inside the housing 2 can be provided to fix spice chambers 6 when they are placed on top. With such an electric drive, the fixation can be loosened in order to exchange one or more spice chambers 6.

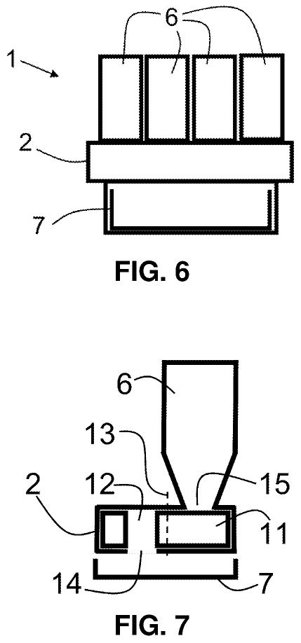

Below the housing 2, there may be a collection chamber 7 open at the top for collecting spices. The collection chamber 7 is removable to allow it to be brought to a food preparation space for emptying after one or more spices have been brought in a dosed manner from the one or more spice chambers 6 to the collection chamber 7. Thus, if a user is prompted by a signal to season ingredients in a food preparation vessel as part of a method as disclosed, the user may remove the collection chamber 7 and pour its contents into the food preparation vessel for seasoning. In this way, the required spices are then dispensed into the food preparation vessel in a dosed manner in appropriate quantities. The collection chamber 7 can be connected to the remaining part of the spice dispensing device 1 in the form of a drawer, as indicated in FIG. 6. Housing 2 and spice chambers 6 are intended for stationary use. Only the collection chamber 7 should be guided by hand in order to be able to season. Housing 2 can therefore be permanently attached to a wall, for example.

The configurations shown in FIGS. 5 and 6 are particularly suitable if more than four spice chambers 6 are to be used. Thus, behind the four spice chambers 6 shown, there can be another four spice chambers 6, so that this spice dispensing device 1 then comprises a total of eight spice chambers 6.

Preferably, it is possible with all spice dispensing devices 1 shown in FIGS. 1 to 6 to dispense manually defined dosage quantities. Spice dispensing devices 1, which comprise a button 3, can be configured such that one of the spice chambers 6 can be selected by pressing the button 3 several times, for example, if the spice dispensing device is in an offline mode intended for this in which no automated seasoning takes place. If a spice chamber 6 has been selected, pressing button 3 for a long time, for example, can cause spice to be removed from the selected spice chamber 6 as long as button 3 is pressed. Spice chambers 6 can be different in color. An optical signal device 4 can then indicate which spice chamber 6 has been selected merely by displaying one color.

With the spice dispensing devices 1, which comprise a removable collection chamber 7, spices in a collection chamber 7 can be manually added to a food in a dosed manner by adding only a desired part from a collection chamber 7 to a food. Manual dosing may also be possible by remote control, for example by means of a mobile phone with a data processing program installed on it.

FIG. 7 illustrates an example of a dosing unit. The dosing unit has a ring 11 with a passage 12. The ring 11 can be rotated around an axis 13. An opening 14 that leads to a collection chamber 7 is located below the passage 12. If there is a spice in the passage 12, this spice enters chamber 7 as soon as the position shown in FIG. 7 is reached by rotating the ring 11. For dosing, the ring 11 is rotated around the axis 13 until the passage 12 is below the opening 15 of the spice chamber 6. The passage 12 is then filled with the spice in the spice chamber 6. If the ring 11 is then rotated 180°, the spice falls into the collection chamber 7. This process is repeated until the desired amount of spice is in the collection chamber 7.

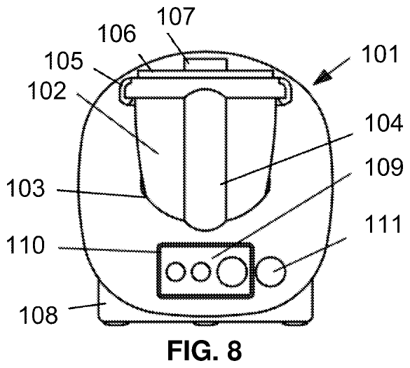

FIG. 8 shows a food processor 101 suitable for performing a method according to the present disclosure. The food processor 101 comprises as food preparation space a food preparation vessel 102, which is inserted into a holder 103 of the food processor 101. The food preparation vessel 102 comprises a handle 104 to enable the food preparation vessel 102 to be easily removed from the holder 103. The food processor 101 comprises a locking device with pivoted arms 105. In the locked position shown in FIG. 1, the arms 105 enclose a lid 106. This ensures that the lid 106 is then firmly attached to the food preparation vessel 102. The lid 106 comprises an opening into which a transparent measuring vessel 7 is inserted. The measuring vessel 7 closes the opening in the lid 106. The transparent measuring vessel 7 can be lifted off the opening at any time, thus providing an opening through which an ingredient can be poured into food preparation vessel 102. The transparent measuring vessel 107 can serve as a dosing aid. A spice from the spice dispensing device 1 can be poured into the transparent measuring vessel 107. Then, the spice in the transparent measuring vessel 107 can be poured into the food preparation vessel 102. This prevents the spice dispensing device 1 from being exposed to moisture from the food preparation vessel 102. If the closing mechanism is opened, the lid 106 can be removed from the food preparation vessel 102. The food processor 101 comprises a foot section 108 for setting up.

A user interface 109 is displayed on a screen 110. The screen 110 is preferably touch-sensitive, for example to be able to set operating parameters by touching the screen. The food processor may also comprise, for example, a control dial 111, which can also serve to set one or more operating parameters in conjunction with the user interface 109. For example, if user interface 109 refers to a mixing device of the food processor 101, the control dial 111 can e.g. be used to set a rotation speed. For example, if user interface 109 refers to heating the food preparation vessel 102 of food processor 101, the control dial 111 can be e.g. used to set a desired temperature. However, instead of a rotary control 111, a slide control can also be provided, for example, where operating parameters such as temperature, stirring speed or a time period can be set by a sliding movement. A control dial 111 is preferable, however, since large ranges can be set without having to provide too much space. The control dial 111 can alternatively or additionally be configured as a push button. Push button means that it can be pressed to trigger an action, such as starting a preparation of one or more foods.

The food processor 101 shown in FIG. 8 comprises at least one interface for connecting the food processor 101 to another household appliance. The at least one interface is, for example, a wireless interface for exchanging data via common standards such as WLAN or Bluetooth.

The food preparation apparatus comprises a food preparation space. The food preparation space is a space limited by walls in which ingredients for the preparation of a food can be brought. The ingredients brought into the food preparation space can be processed by the food preparation apparatus, for example, heated, chopped and/or mixed. The food preparation space can be inseparably connected to the rest of the food preparation apparatus. The food preparation space may be a food preparation vessel which can be separated from the rest of the food preparation apparatus. The food preparation vessel may comprise a lid with which an opening in the food preparation vessel can be closed. An electrical locking device may be provided firmly connect the lid to the food preparation vessel. If the electrical locking device locks the lid, the lid cannot be removed from the food preparation vessel. The locking can preferably be controlled by the control unit, e.g. in an automated manner depending on a recipe step of a recipe. The lid may comprise an opening that can be closed, for example by a measuring vessel. Through the opening in the lid, ingredients, such as spices, can be filled into the food preparation vessel even if the lid is locked by the locking device and therefore cannot be removed from the food preparation vessel.

A control unit in the sense of the present disclosure comprises a data processing device with which data can be electronically processed. A control unit in the sense of the present disclosure may comprise an electronic memory in which data can be stored.

The food preparation apparatus may comprise an electronic memory. In such an electronic memory one or more recipes may be electronically stored.

The food preparation apparatus may comprise one or more interfaces through which electronic data can be sent and/or received. One or more wireless interfaces can be used to be able to send and/or receive electronic data wirelessly. If one or more interfaces are provided, one or more recipes may be stored in an external electronic memory. An external electronic memory is a memory that is spaced apart from the food preparation apparatus. The food preparation apparatus may then be configured such that it can receive a recipe from the external electronic memory and process it for preparing a food.

A user can cause the food preparation apparatus to prepare a food according to the stored recipe. By means of the food preparation apparatus, the food is then prepared.

The recipe may comprise a recipe step according to which one or more ingredients are to be filled into the food preparation space of the food preparation apparatus. Controlled by the control unit, the food preparation apparatus can prompt the user to bring the one or more ingredients to the food preparation space. To be able to prompt the user to bring one or more ingredients to the food preparation space, the food preparation apparatus may comprise a screen on which prompts can be displayed.

The food preparation apparatus can be configured such that it detects in an automated manner when the one or more ingredients specified in the recipe have been brought into the food preparation space. The food preparation apparatus may be configured such that a user has to confirm that he has filled the one or more ingredients provided for in the recipe step into the food preparation space before continuing with the food preparation. Confirmation may be effected in that a user causes the food preparation apparatus to perform a next recipe step of the recipe by actuating an actuating device. The actuating device may comprise, for example, a button which must be actuated by pressing for a continuation of the food preparation.

The food preparation apparatus may comprise a scale for weighing the weight of one or more ingredients that have been filled into the food preparation space. The food preparation apparatus may be configured such that the weighing performed in an automated manner controlled by the recipe step. So if one or more ingredients are to be added to the food preparation space according to a recipe step, the scale can be activated in an automated manner. As soon as an ingredient is filled into the food preparation space, the weight is weighed and e.g. displayed on a screen of the food preparation apparatus. The food preparation apparatus may comprise an acoustic and/or optical signal device which emits an acoustic and/or optical signal when an ingredient has been filled in according to the amount required by the recipe step.

The food preparation apparatus may comprise a temperature control device for the temperature control of the food preparation space. A next recipe step may comprise controlling the temperature of one or more ingredients in the food preparation space. In particular, the food preparation apparatus is configured such that controlled by the recipe step, the food preparation space is to temper the one or more ingredients in the food preparation space in an automated manner specified by the recipe step. The next recipe step may provide a temperature to which one or more ingredients have to be brought. The food preparation apparatus may be configured such that the temperature of the one or more ingredients in the food preparation space is controlled in an automated manner according to the recipe step, i.e. the one or more ingredients are brought to the temperature specified according to the recipe step. The recipe step can provide a time period for controlling the temperature of one or more ingredients. The food preparation apparatus can be configured such that it controls the temperature of the one or more ingredients in the food preparation space for the time specified according to the recipe step in an automated manner.

The food preparation apparatus may comprise a mixing tool for mixing and/or chopping ingredients in the food preparation space. A next recipe step may comprise mixing and/or chopping of one or more ingredients in the food preparation space. The food preparation apparatus is in particular configured such that the food preparation apparatus, controlled by the recipe step, mixes and/or chops the ingredients in the food preparation space in the manner specified by the recipe step in an automated manner. The recipe step may provide a time period for mixing and/or chopping the ingredients. The food preparation apparatus may be configured such that it mixes and/or chops the one or more ingredients in the food preparation space in an automated manner for the time specified by the recipe step. The recipe step may provide a rotation speed for the mixing tool to mix and/or chop ingredients. The food preparation apparatus may be configured such that it sets the speed of rotation according to the recipe step in an automated manner.

The food preparation apparatus does not have to perform one or more of the above settings in an automated manner according to the recipe step. Instead, the food preparation apparatus may optically and/or acoustically prompt a user to manually perform a setting intended to be performed according to a recipe step. For example, a user may be prompted to manually set a mixing tool rotation speed for mixing and/or chopping ingredients.

The method comprises the use of an electrically operable spice dispensing device. The spice dispensing device therefore usually comprises a battery provided in the spice dispensing device to be able to provide electrical energy for operation. The battery may be rechargeable. However, it is also possible that the spice dispensing device can be connected to an external electrical power source via an electrical cable to provide power for operation.

The spice dispensing device comprises at least one spice chamber for storing a spice. It is preferably a dry spice stored in the spice chamber for performing the method, such as peppercorns, ground pepper, salt, sugar, nutmeg or dried herbs. A spice mixture can be stored in a spice chamber, for example a homogeneous mixture of salt and ground herbs. Such a mixture is also called herbal salt. A liquid spice mixture is also possible.

The spice dispensing device comprises a dosing device through which a predetermined amount of spice can be removed from the spice chamber and thus in dosed form. The removal of a predetermined amount or a predetermined dose can be performed in an automated manner. By the automated dosing manual dosing is avoided, which could easily result in an incorrect dosage. The fact that automated dosing is possible does not exclude the possibility of dosing manually. Automated dosing means that a user cannot influence the amount of spice based on automated dosing. This is not opposed to the fact that in one configuration of the disclosed embodiments it may be necessary that automated dosing is only performed when activated by a user, for example by actuating a switch or a button. Incorrect dosages based on human intervention are thus avoided.

The spice dispensing device may comprise a grinder by means of which e.g. peppercorns stored in the spice chamber or a nutmeg stored in the spice chamber can be comminuted. An electric motor may be provided to electrically drive the grinder. The spice dispensing device can be configured so that grinding with the grinder can be controlled by an electronic control unit. The electronic control unit can be part of the spice dispensing device. The electronic control unit can be the control unit with which the preparation of the food is controlled according to recipe steps of a recipe. The electronic control unit as part of the spice dispensing device means a control unit physically connected to the spice dispensing device and used for control of the dosage, but in principle not for control of the preparation of the food according to recipe steps.

Through the grinder, a spice can be removed from the spice chamber in a dosed manner, namely by controlling the grinding time with an electronic control unit. The grinder can be configured such that the grinding level can be adjusted by the control unit. For example, it can be adjusted whether a pepper grain is coarsely or finely comminuted by grinding. The grinder can be configured in such a way that the grinding speed can be adjusted by a control unit. The speed of rotation of the grinder is then set. The grinder can therefore form the dosing device with which a quantity of spice can be dosed in an automated manner. Commercially available grinders for spice mills can be used as grinders.

The dosing device may comprise one or more rotatable or slidable passages. By rotating or sliding, a passage can reach a lower opening of a spice chamber with a spice stored therein. The lower opening of the spice chamber is then located above the passage. The passage can then be filled with spice due to gravity. If the passage is rotated or slided further to an opening that is located below the passage, the spice in the passage can leave the passage downwards due to gravity. In this way spice can be dosed. The rotation or sliding of the one or more passages can be controlled by an electronic control unit, such it can be dosed in an automated manner.

The dosing device can be configured in the manner known from US 2016/0374486 A1.

The method comprises the following steps:

In the food preparation space a food is prepared controlled by a control unit according to recipe steps of a recipe. The recipe is therefore divided into a plurality of recipe steps. A recipe step may require a user to take action. However, a recipe step can also be such that it is performed in an automated manner by the food preparation apparatus wherein, thus, the user does not take action. A recipe step may comprise temperature control, mixing and/or chopping of one or more ingredients. A recipe step can comprise the addition of one or more ingredients. If one or more spices are to be added according to the recipe step, this recipe step is also called a spice recipe step. The recipe comprises such a spice recipe step according to which at least one spice is to be added.

If the spice recipe step is reached during the preparation of a food, a signal is triggered by a signal device in a manner controlled by the control unit. This can be an optical signal and/or an acoustic signal. Through the signal the user is informed that one or more spices should be brought into the food preparation space. It is therefore preferable that the spice dispensing device comprises the signal device. If the spice dispensing device emits the signal, this is an immediate indication that the spice dispensing device which has signaled this is now to be used. If there is an acoustic signal, it is very easy for a user to notice the signal during the preparation of a food and to locate the spice dispensing device.

Following the signal, a user grasps the spice dispensing device and brings the spice dispensing device to the food preparation space in such a way that a spice from the spice dispensing device can be dispensed into the food preparation space. The spice dispensing device can then be located above an opening that leads into the food preparation space. It is also possible that the food preparation space comprises a door. This door is opened to bring the spice dispensing device into the food preparation space for seasoning.

However, a user can also bring the spice dispensing device to a measuring vessel following the signal in such a way that the spice from the spice dispensing device can be dispensed into the measuring vessel. This has the advantage that the spice dispensing device is not exposed to moisture caused by preparing food in the food preparation space.

If the spice dispensing device has been moved by the user to the food preparation space or to the measuring vessel for a seasoning, the spice dispensing device dispenses the amount of spice to be added according to the spice recipe step in a dosed manner, wherein the dosing has been performed in an automated manner. The dosage has thus been controlled by a control unit. The dosage may have been directly controlled by a control unit that is physically connected to the food preparation apparatus. However, the control unit of the food preparation apparatus may also have transmitted an instruction to the spice dispensing device to dose a spice. In this case the electronic control unit, which is part of the spice dispensing device, can take over the dosing of the spice.

If the spice from the spice dispensing device has first been dispensed in a dosed manner into the measuring vessel, the spice is brought from here further into the food preparation space for seasoning. A user can manually add the spice from the measuring vessel to one or more ingredients present in the food preparation space according to the spice recipe step. However, it is also possible that this is performed in an automated manner.

Alternatively, the spice dispensing device may comprise a removable collection chamber in which the spice removed from the spice chamber in a dosed manner is collected. In this case, the user can remove the collection chamber and pour its contents into the food preparation space or into the measuring vessel.

Through the method, errors in the preparation of food due to incorrectly dosed spices can be prevented in an improved manner. The error-free success of a food is thus further simplified, especially for inexperienced users. Due to the teaching of the present disclosure, expert knowledge about the seasoning of food is not required. A precise dosage of smallest quantities can be realized.

In one embodiment, the spice dispensing device comprises a plurality of spice chambers. In each spice chamber a spice is stored. A spice in one spice chamber is different from a spice in another spice chamber. By means of the spice dispensing device, different spices can be added in a dosed manner.

In one embodiment of the method, a plurality of spice dispensing devices is used for the preparation. The spice dispensing devices are not physically connected to each other and can be used independently of each other. A spice in one spice dispensing device is then different from a spice in another spice dispensing device. For example, a first spice dispensing device may contain salt and a second spice dispensing device may contain pepper. If, for example, salting is planned according to a spice recipe step, a user is informed by a corresponding signal that the spice dispensing device with the salt is now to be used. The most reliable and easiest way to do this is that the spice dispensing device with the salt stored in it emits an acoustic signal via loudspeaker and/or a visual signal via screen or light source. If pepper is intended according to a spice recipe step, a user is informed by a corresponding signal that the spice dispensing device with the pepper is now to be used. The most reliable and easiest way to do this is that the spice dispensing device with the pepper stored in it emits a signal. If the respectively required spice dispensing device emits a signal, confusion can be avoided in an improved manner.

In one embodiment, according to the spice recipe step, a plurality of spices are to be added, which are stored in spice chambers of the spice dispensing device. The spices are removed from the spice chambers in a correspondingly dosed manner and added in the form of a spice mixture to minimize the time required. Spice mixture means that the spices are added together, i.e. not one after the other and thus not separately. It is possible, for example, that a dosed removal of the intended spices from the spice chambers has already been performed before reaching the spice recipe step or directly after reaching the spice recipe step. The spice dispensing device may comprise a collection chamber in which the spices removed from the spice chambers in a dosed manner can be collected. The spices collected in the collection chamber then form a spice mixture as described in this disclosure. As soon as the spice mixture is to be brought into the food preparation space, for example, a closure of the collection chamber is opened in such a way that the spice mixture can be brought from the collection chamber into the food preparation space or at least into a measuring vessel. In one embodiment, the closure can be opened manually. In one embodiment, the closure can be opened by motor. In one embodiment the opening of the closure can be controlled by one of the mentioned control units. The closure is not absolutely necessary. The collection chamber may have a lateral opening which cannot be closed and through which spices can be dispensed from the collection chamber.

If the collection chamber is the mentioned removable collection chamber, the mentioned opening with the closure is not necessary and can therefore be omitted. A lateral opening, which cannot be closed, is then also not necessary.

The control unit which controls the preparation of a food, can be integrated into the food preparation apparatus, i.e. it can be physically connected to other components of the food preparation apparatus in a fixed and permanent way. However, it is also possible that the control unit is physically separated from other components of the food preparation apparatus and, for example, a control is carried out via wireless data exchange.

In one embodiment of the method, the food preparation apparatus sends control commands of the control unit wirelessly to the spice dispensing device to cause the spice dispensing device to dose a spice. After receiving these control commands, spice is removed from the spice chamber in a dosed and automated manner.

The food preparation apparatus may comprise the signal device. Preferably, however, the spice dispensing device comprises the signal device, since the user's attention is immediately drawn to the spice dispensing device when a signal is triggered. However, it is also possible that the signal device is a device that is physically separate from the food preparation apparatus and the spice dispensing device and that can receive data from the control unit, for example, wirelessly.

The fact that the spice dispensing device is an electrical spice dispensing device is not absolutely necessary to solve the task. The method can also advantageously be performed with a spice dispensing device that comprises a dosing device which is to be actuated mechanically. Such a spice dispensing device can, for example, comprise a rotating mechanism that can be rotated in steps, for example in 180° steps. The steps can be indicated by markings. The steps can be indicated to a user by means of a latch mechanism. The spice dispensing device can be configured to dispense a defined amount of spice per step, thus facilitating the dosage. When a spice recipe step is reached, a user can be prompted, for example, via a display on a screen, to rotate the rotating mechanism according to a specified number of steps in order to season in an improved and dosed manner. In this embodiment, however, it is possible that a user inadvertently rotates the rotating mechanism beyond the number of steps specified for a dosage or does not rotate the rotating mechanism to the specified number of steps. However, it is still possible in an improved manner that a food is a reliable success even for inexperienced users, as a user can prepare the food by means of easy to understand instructions without the need for expert knowledge. In terms of mechanics, such a dispensing device can be configured as the dosing unit known from US 2016/0374486 A1.

The present disclosure also relates to an electrical, at least partially handheld spice dispensing device for performing a method according to the disclosure. The spice dispensing device comprises at least one spice chamber in which a spice can be stored. The spice dispensing device comprises a dosing device which can dose spice stored in the spice chamber in an automated manner. The spice dispensing device comprises a dispensing device with which the dosed amount of spice can be dispensed into a food. By the possibility of dosing in an automated manner the success of a food can correspondingly be ensured in an improved manner.

“At least partially handheld” means that the spice dispensing device or a part thereof is intended and suitable to be held by hand and guided by hand to season a food. It is therefore not a device which, by virtue of its size and weight alone, is not suitable for being held for seasoning with one hand. It is also principally not a device that is not only capable of seasoning, but that also comprises, for example, a food preparation space in order to be able to perform other tasks in the preparation of a food. It is therefore possible that the spice dispensing device for seasoning must be completely hand-held, as is known from conventional pepper mills for private households. However, it is also possible that only a part of the spice dispensing device for seasoning must be guided by hand.

The dispensing device can be a removable collection chamber in which spice dosed by the spice dispensing device can be collected. The manually operated part of the spice dispensing device can be this removable collection chamber. Spice collected in the collection chamber can in this case be dispensed by removing the collection chamber and pouring its contents for seasoning. The detachable collection chamber can be detachably connected to the rest of the spice dispensing device in the manner of a drawer. The collection chamber can then be pulled out and put back in like a drawer. The removable collection chamber can be detachably connected to the rest of the spice dispensing device by means of a screw cap or bayonet joint. The collection chamber can then be detached from the remaining part of the spice dispensing device or connected to the remaining part of the spice dispensing device with a rotational movement.

The dispensing device can be a collection chamber with a side opening, in which spice, which has been dosed by the spice dispensing device, can be collected. The side opening is then located above the bottom of the collection chamber. Spices collected in the collection chamber can then be dispensed by tilting the spice dispensing device so that spices collected in the collection chamber fall by gravity through the side opening. The side opening can be permanently open. However, it is also possible that there is a closure for the side opening. The closure can be a stopper. The closure can be a pivoting flap. The closure can be a screw cap. If the opening comprises a closure, the opening can also be in the bottom of the collection chamber.

In one embodiment of the present disclosure, the spice dispensing device comprises an actuating device, the actuation of which has the effect that an amount of spice dosed by the dosing device is dispensed by the dispensing device. The dispensing device may be purely mechanical. Actuation may therefore have the effect that an opening closed by a closure is mechanically opened. Afterwards, spice can be dispensed by gravity, for example. The dispensing device can also comprise an electrical element which causes the opening to be opened electrically. The electrical element can be an electric motor or an electromagnet. Thus, when actuated, the electromagnet can be switched on. Subsequently, the electromagnet can, for example, attract or repel a closure due to magnetic force to open the opening. After the electromagnet is switched off, the closure can then be moved back into its closed position, for example by spring force, and the opening can thus be closed again.

In one embodiment of the present disclosure, the spice dispensing device comprises a detection device with which it can be detected, i.e. determined, whether the spice dispensing device is located above a food preparation space. The detection device may comprise an RFID chip, for example. The food preparation apparatus then comprises a transponder for the RFID chip. The transponder is arranged such that it locates the RFID chip if the spice dispensing device is located above the food preparation space. It can thus be detected or determined that or whether the spice dispensing device is located above the food preparation space of the food preparation apparatus. Alternatively, the detection device can comprise the transponder and the food preparation apparatus the RFID chip. However, it is preferable that the detection device comprises the RFID chip in order to minimize the power consumption of the spice dispensing device. This is particularly advantageous if the spice dispensing device is powered by means of a battery. In an improved manner, this enables long lifetimes for the spice dispensing device without having to provide an excessively large battery. Detection can also be realized by means of near field communication (NFC). Instead of RFID technology, another contactless data exchange over short distances of a few centimeters can be used to detect that or whether the spice dispensing device is located above the food preparation space of the food preparation apparatus. For this purpose, the detection device may comprise, for example, a coil that is used for such a contactless data exchange over short distances. The detection device may also comprise one or more other sensors which can be used to determine a sufficient proximity to the food preparation space. Magnetic forces can be used to detect an approach. For this purpose, the detection device may comprise a permanent magnet. The food preparation apparatus may comprise a magnetic field detector. If by means of the magnetic field detector it is determined that the permanent magnet is approaching the detection device, it can be determined that the spice dispensing device is located above the food preparation space.

The spice dispensing device may be configured such that the dispensing device dispenses a quantity of spice dosed by the dosing device when the detection device detects that the spice dispensing device is located above a food preparation space. This further simplifies the food preparation for a user.

In one embodiment of the disclosure, the spice dispensing device comprises a mechanical opening mechanism which can be opened mechanically by placement on the food preparation space. In this embodiment, a user places the spice dispensing device on the food preparation space in the designated manner, whereby the spice dispensing device is opened such that appropriately dosed spices fall out of the spice dispensing device. The spice dispensing device may comprise a flap mechanism such that a flap is opened upon placement. The spice can then fall out of the spice dispensing device through an opening thus opened.

In one embodiment of the present disclosure, the spice dispensing device comprises a wireless interface for receiving and/or sending data. This makes it possible, for example, that one or more commands are transmitted to the spice dispensing device, which cause the spice dispensing device to dose a spice. This spice is then removed from the spice chamber in which the spice is located in a dosed manner.

In one embodiment of the disclosure, the spice dispensing device comprises a signal device which can be caused to emit a signal by receiving data via an interface. The interface is in particular the aforementioned wireless interface.

The signal device can be an optical signal device and/or an acoustic signal device. An optical signal device can be realized for example by one or more LEDs. The optical signal device may comprise a screen. A loudspeaker can serve as acoustic signal source.

In one embodiment, the spice dispensing device comprises a plurality of spice chambers for storing different spices. There can be provided only one dosing device which can dose one spice from each spice chamber. For example, two spice chambers may be present. The dosing device may comprise a passage which can be moved to a lower opening of the one or the other spice chamber in order to be able to remove spice from the selected spice chamber in a dosed manner.

However, each spice chamber can also have its own passage which is used for dosing. In this way, contamination of one spice with remaining ingredients of another spice in one passage is avoided. Each spice chamber can be a cartridge with its own dosing unit, as is known e.g. from publication US 2016/0374486 A1.

In one embodiment, the spice dispensing device comprises a dispensing device configured such that it can dispense a plurality of different spices dosed by the dosing device as a spice mixture. This spice dispensing device may comprise a collection chamber into which spices from spice chambers can be brought in a dosed manner before spices from the collection chamber can leave the spice dispensing device, for example through a closable opening. In this case, the opening is only opened when one or more spices collected in the spice chamber are to be dispensed.

A dispensing through the dispenser can be effected for example by pressing a button.

In one embodiment, there is a data processing program and a user interface for the spice dispensing device such that a user can individually control the spice dispensing device by means of the user interface. By means of the user interface, for example, a spice can be dosed in one embodiment. The user interface is designed such that a user can set a desired dosage. This embodiment also allows a user to season according to their own taste preferences. This means that a user does not have to use the automated dosage of a spice when preparing a food. Instead, he can season individually at the appropriate time by means of the user interface. In one embodiment, the data processing program can be designed for installation on a mobile phone. It may also be designed to be installed on the food preparation apparatus or already installed in the spice dispensing device. An individual adaptation of food to taste preferences with the least effort and with the highest quality of results is thus possible. The data processing program can be part of an operating system of the food preparation apparatus or the spice dispensing device.

1. A method for preparing a food with a food preparation apparatus and an electrically operable spice dispensing device, wherein the food preparation apparatus has a food preparation space and the spice dispensing device comprises a spice chamber for storing a spice and a dosing device through which a spice can be removed from the spice chamber in a dosed manner, comprising the steps:
preparing a food in the food preparation space of the food preparation apparatus as the food preparation apparatus is controlled by a control unit according to recipe steps of a recipe, wherein the recipe comprises a spice recipe step according to which a spice is to be added,
triggering a signal device controlled by the control unit, when the spice recipe step is reached,
grasping the spice dispensing device and bringing the spice dispensing device to the food preparation space in such a way that a spice from the spice dispensing device can be dispensed into one of the food preparation space and a measuring vessel, and
dispensing the amount of spice to be added according to the spice recipe step in a dosed manner from the spice dispensing device if the spice dispensing device has been brought to one of the food preparation space and the measuring vessel, wherein the dosing has been performed in an automated manner by the dosing device.

2. The method of claim 1, wherein the spice dispensing device comprises a plurality of spice chambers and a spice is stored in each spice chamber, wherein a spice in one spice chamber is different from a spice in another spice chamber.

3. The method of claim 2, wherein according to the spice recipe step a plurality of spices are to be added and the spice dispensing device dispenses the spices to be added according to the spice recipe step in a dosed manner in the form of a spice mixture, wherein the dosing of each spice has been performed in an automated manner by the dosing device.

4. The method of claim 3, wherein the control unit is integrated in the food preparation apparatus.

5. The method of claim 4, wherein the food preparation apparatus sends control commands of the control unit wirelessly to the spice dispensing device, and the spice dispensing device is thereby caused to dose a spice.

6. The method of claim 5, wherein the spice dispensing device comprises the signal device.

7. The method of claim 1, wherein the control unit is integrated in the food preparation apparatus.

8. The method of claim 1, wherein the spice dispensing device comprises the signal device.

9. An electrically operable, at least partially handheld spice dispensing device for dispensing into a food preparation device an amount of spice to be added defined by a spice recipe step in a dosed manner, the spice dispensing device comprising
a spice chamber in which a spice can be stored,
a dosing device which can dose spice stored in the spice chamber in an automated manner, and
a dispensing device with which the dosed amount of spice can be dispensed into a food.

10. The spice dispensing device of claim 9, further comprising an actuating device, the actuation of which has the effect that an amount of spice dosed by the dosing device can be dispensed by the dispensing device.

11. The spice dispensing device of claim 9, further comprising a detection device with which it can be determined that the spice dispensing device is located above a food preparation space, and said spice dispensing device is configured such that said dispensing device dispenses an amount of spice dosed by said dosing device when it is determined by means of said detection device that said spice dispensing device is located above a food preparation space.

12. The spice dispensing device of claim 11, further comprising a wireless interface is provided for receiving and/or sending data.

13. The spice dispensing device of claim 12, further comprising a signal device which can be caused to emit a signal in response to receipt of data via the wireless interface.

14. The spice dispensing device of claim 13, wherein the signal device is at least one of an optical signal device and an acoustic signal device.

15. The spice dispensing device of claim 14, wherein the dosing device can be caused to remove a spice from the spice chamber in a dosed manner by receiving data via the wireless interface.

16. The spice dispensing device of claim 15, wherein a plurality of spice chambers is provided for storing different spices and the dosing device can dose spice from each spice chamber.

17. The spice dispensing device of claim 16, wherein the dispensing device is configured such that it can dispense a plurality of different spices, which have been dosed by the dosing device, as a spice mixture.

18. The spice dispensing device of claim 9, further comprising a wireless interface is provided for receiving and/or sending data.

19. The spice dispensing device of claim 18, further comprising a signal device which can be caused to emit a signal in response to receipt of data via the wireless interface.

20. The spice dispensing device of claim 19, wherein the signal device is at least one of an optical signal device and an acoustic signal device.
